(19) United States
(12) Patent Application Publication
(10) Pub. No.: US 2019/0357458 A1
(43) Pub. Date: Nov. 28, 2019

(54) AEROPONIC PLANT GROWING SYSTEM AND METHODS OF USE

(71) Applicant: CanMax Growing Holdings Inc., Calgary (CA)

(72) Inventors: Andres Cordoba, Calgary (CA); Karlo Slisko, Calgary (CA)

(21) Appl. No.: 16/419,972

(22) Filed: May 22, 2019

Related U.S. Application Data
(60) Provisional application No. 62/675,254, filed on May 23, 2018.

(51) Int. Cl. A01G 31/02; A01G 9/24

(52) U.S. Cl. CPC A01G 31/02; A01G 2031/006; A01G 9/24

(57) ABSTRACT

Apparatus and methodologies for aeroponically growing a large crop of plants are provided, comprising at least one climate-controlled growth chamber containing a plurality of independently rotatable plant support structures for receiving and supporting a plurality of plants in close proximity to one another, providing easy access to the plants within the growth chamber without interruption delivery of a nutrient-rich solution to the plants. Where desired, each plant support structure may also be quickly and easily removed from the growth chamber, via at least one quick-release mechanism.

### CROSS-REFERENCE TO RELATED APPLICATION

The present application claims the benefit of the filing date of U.S. Provisional Patent Application No. 62/675,254, entitled “AEROPONICS SYSTEM AND METHODS OF USE,” and filed on May 23, 2018, the entire contents of which is incorporated herein by reference as if set forth in full.

### FIELD

Apparatus and methodologies are provided for improved aeroponic plant growing. More specifically, improved aeroponic plant growing systems and methods of use are provided, wherein the plants may be marijuana plants.

### BACKGROUND

Aeroponics is the process of growing plants without the use of soil or an aggregate medium. Aeroponics systems traditionally involve suspending the plants in a closed or semi-closed environment and then spraying the plant's roots with an air or mist of nutrient-rich water solution. The oxygen-rich environment created within aeroponic systems enables plants to absorb more nutrients while using less water than conventional growing methods, increasing crop maturation rates and yields. As a result, harvests from aeroponic growing systems are significantly larger than soil-grown plants (e.g. as much as 10 times larger).

Conventional aeroponic systems comprise an enclosed grow chamber separated into two main portions: a first upper portion configured to house the plant canopy, referred to as the “canopy zone”; and a second lower portion configured to house the root portion of the plant, referred to as the “root zone”. The two zones are physically separated, such as by a foam disc wrapped around the stem of the plant, such that the roots of the plant may be sprayed with the nutrient-rich solution. Due to the roots being exposed to the environment, aeroponics systems must be carefully monitored and maintained in order to maximize nutrient availability to the roots, and disruptions to the environment should be avoided in order avoid contamination of the system.

The highly-controlled nature of aeroponic plant growing processes makes them an ideal system for growing government-regulated plants, such as marijuana (marihuana), where strict parameters surrounding the production of the plant are imposed and enforced by health and safety organizations (e.g. Health Canada). For example, where the marijuana is grown for medical purposes (or even recreational use, where legal), government agencies impose restrictions on the odour or pollen that can be emitted from growth chambers, and the final plant product must pass strict lab testing to ensure that inorganics, such as pesticides or heavy metals, are not present. Moreover, organics such as mold spores, mildew, and bacteria etc. must also not be present. Due to the strict growing requirements, systems where the plants are protected from exposure to sources of contamination in the air or water are desirable. Moreover, systems that provide increased crop maturation rates and yields without the use of pesticides or other chemical additives are also desirable.

On the other hand, the delicate growing environment of aeroponics systems can make them difficult to use successfully, particularly on a large scale. Without soil or other growth medium as a buffer, plant roots can quickly dry out and die when the environment becomes disrupted, for example, where air quality, temperature, pressure or humidity are altered, nutrient-mist composition is poorly applied where pumps or misters become clogged, or where human intervention disturbs the plants, etc. However, many plants, including marijuana plants, benefit from regular pruning of lower portions of the plant canopy (e.g. where light is restricted, causing underbalanced distribution of nutrients), resulting in regular “disruption” to the aeroponic environment. Although regular pruning can increase both the density and yield of the plants, it must be performed in a manner that minimizes disturbance of the growth chamber environment and the surrounding plants. Moreover, parameters within aeroponics systems must be closely measured and controlled order to ensure desired levels are maintained within the system.

There is a need for an improved aeroponic plant growing system that can be used with minimal interruption to the growth chamber and the plants housed therewithin. It is desirable that the system be a closed-loop automated (or semi-automated) system where the upper and lower portions of the growth chamber can be monitored and controlled independently, and minimizing the likelihood of contaminants (e.g. mold or mildew) and enabling stringent control over the emission of odour and pollen. It is also desirable that the system provide an expansive growing area, i.e. to maximize volume within the growth chamber, and where the growing area is rotatable for enhanced nutrient supply and drainage. Finally, it is desirable that the system provide easy access to the plants for inspection, pruning, and harvesting, while maximizing the growth space within the growth chamber.

There is a further need for an improved aeroponic plant growing system, such as an aeroponics system, that can be used to grow a large number of plants without significantly increasing the resources, the environmental impact, the complexity or overall footprint of the system. It is desirable that the system be as compact and space efficient as possible, requiring minimal human interaction to grow the crop, and allowing easy harvesting of plants or cleaning and maintenance of the system. It would be advantageous for such an improved system to be equipped with sensors for monitoring and managing growth processes, and to alert or alarm the grower where troubleshooting is needed or problems arise.

### SUMMARY

According to embodiments, improved apparatus and methodologies for aeroponically growing a large crop of plants are provided. More specifically, an aeroponic plant growing apparatus is provided comprising at least one climate-controlled growth chamber containing a plurality of plant support structures for receiving and supporting a plurality of plants in close proximity to one another. Each plant support structure may be independently rotatable about a central axis, and may contain a divider for separating the plant support structure into an upper zone for supporting a canopy portion of the plant, and a lower zone for supporting a root portion of the plant. Each plant support structure may also contain at least one valve for establishing fluid connection with a nutrient solution delivery system, such that the plant support structures may be rotated without interrupting delivery of a nutrient-rich solution to the plants. The at least one valve further provides that each plant support structure can be quickly and easily removed from the growth chamber, via a quick-release mechanism, where desired.

In some embodiments, the system may comprise a closed-loop apparatus, wherein each at least one climate-controlled growth chambers may be enveloped by a material forming a ‘wall’, such material comprising a non-porous, light-reflective material. The at least one growth chambers may be configured to maximize the overall growing area, and may be stacked one upon another, with each chamber still being monitored and controlled by a single controller, processor, or control system.

In some embodiments, the system may further comprise a nutrient delivery system (or irrigation system) in fluid communication with each plant support structure within the growth chamber. The nutrient delivery system may be configured to deliver a nutrient-rich solution to the lower zone of each plant support structure, and to retrieve excess solution draining therefrom (i.e. solution that is not absorbed by the root portion of the plants within the lower zone). Retrieval of un-used nutrient solution may be retrieved within the closed-loop system, providing controlled recirculation of the solution, reducing losses, and eliminating the risk of contamination of the solution.

In some embodiments, the system may further comprise a plurality of sensors for measuring the closed-loop environment within each growth chamber, and to generate a signal indicative thereof. Such sensors may include, without limitation, temperature, pressure, humidity, CO₂, etc. of the air, the fluids, or a combination thereof within the systems. The system may further comprise a single controller, processor, or control system for receiving the signals from the sensors, the single controller, processor, or control system being programmed to control the climate within each at least one growth chamber.

In some embodiments, each of the plurality of plant support structures may further comprise at least one valve (e.g., a rotating coupler) sealably positioned within the plant support structure for establishing fluid communication between the nutrient delivery system and at least one fluid manifold for delivering the fluid to the root zone of the plants. Advantageously, the at least one valve provides means for rotating each plant support structure independently about its central axis, while the plant support structure remains connected to the closed-loop nutrient delivery system. As such, each individual plant support structure may be rotatable without being disconnected from the growth chamber, and without interruption to the nutrient delivery system cycling fluids into and out of each plant support structure.

In some embodiments, the at least one valve comprises a housing for releasably connecting a stationary coupler shaft with a rotatable manifold (nozzle) mount. The releasable connection between the housing and the shaft may comprise a first quick-release mechanism, while the releasable connection between the housing and the mount may comprise a second quick-release mechanism. In some embodiments, first and second quick release mechanisms may comprise a lock-spring.

According to embodiments, methods of growing plants aeroponically are provided, the methods comprising providing a plurality of rotatable plant support structures releasably positioned within at least one climate-controlled plant growth chamber, each plant support structure having a divider for dividing the structure into an upper zone for supporting a canopy, and a lower zone for supporting a root portion of the plants, and planting a plurality of plants within the plant support structures.

In some embodiments, the method further comprises providing a closed-loop nutrient-rich solution to the root portion of the plants in the lower zone, and retrieving excess solution draining therefrom. The method may further comprise providing a plurality of sensors for measuring the climate within each plant support structure and generating signals indicative thereof, providing a controller for receiving the signals from the sensor and, based on the signals received from the sensors, controlling the climate within each growth chamber. Methods further comprise planting a plurality of plants within each plan support structure and supplying the root portion of the plants with a nutrient-rich solution (via a closed-loop fluid system) and, where desired, rotating one or more plant support structures to access the plurality of plants.

In some embodiments, the method further comprises providing at least one valve sealably positioned within each plant support structure, the valve comprising at least one quick-release mechanism for removal of some or all of the plant support structure from the growth chamber. The at least one quick-release mechanism may comprise a first lock-spring for removing a manifold from the plant support structures, and a second lock-spring for removing the plant support structures from the growth chamber.

### BRIEF DESCRIPTION OF THE FIGURES

FIG. 1 is a perspective view of the present aeroponics system according to embodiments herein, the system having at least six plant support structures within one growth chamber. It should be appreciated that the present system comprises growing the plants within an enclosed or enveloped chamber, such that the climate-controlled chamber creates a closed-loop environment;

FIG. 2 is a side view of the aeroponics system shown in FIG. 1;

FIG. 3 is a zoomed in perspective view of the present aeroponics system according to embodiments herein;

FIG. 4 is a cross-section of the perspective view in FIG. 3, wherein the front three plant support structures within the growth chamber are removed for illustrative purposes;

FIG. 5 is a zoomed in view of the present aeroponics system according to embodiments herein;

FIG. 6 is a perspective view of a rotatable plant support structure, according to embodiments herein;

FIG. 7A is a top down view of the present rotatable plant support structures, according to embodiments herein;

FIG. 7B is a top down view of a divider for positioning into a plant support structure, according to embodiments herein;

FIG. 8 is a zoomed in perspective view of the underside of a plant support structure, according to embodiments herein;

FIG. 9 is a zoomed in perspective view of a rotating coupler positioned within the drain hole of a plant support structure, according to embodiments herein;

FIG. 10A is an isolated perspective view of the coupler shown in FIG. 9, and FIG. 10B provides a cross-sectional side view of the coupler, according to embodiments herein;

FIGS. 11A, 11B, and 11C show different views of the rotating coupler housing in isolation, according to embodiments, where FIG. 11A shows a perspective view of the housing, FIG. 11B shows a cross-section perspective view, and FIG. 11C shows a cross-section side view;

FIGS. 12A, 12B, and 12C show different views of the rotating coupler shaft in isolation, according to embodiments, where FIG. 12A shows a perspective view of the shaft, FIG. 12B shows a cross-section perspective view, and FIG. 12C shows a cross-section side view;

FIGS. 13A, 13B, and 13C show different views of the spray nozzle mount in isolation, according to embodiments, where FIG. 13A shows a perspective view of the mount, FIG. 13B shows a cross-section perspective view, and FIG. 13C shows a cross section side view;

FIG. 14 shows different view of the lock-spring in isolation, according to embodiments, where FIG. 14A shows a perspective view of the lock-spring, FIG. 14B shows a top view, and FIG. 14C shows a side view;

FIG. 15 shows a list of symbols and standard naming convention used for FIGS. 16-19, and also includes a representation of the present system having an example of up to twenty growth chambers according to embodiments, wherein the representation includes, for example, a nutrient center and nineteen elevated or ‘stacked’ growth chambers (names are given to each chamber based on function and location, e.g., C41 denotes a growth chamber in the first column of level 4);

FIG. 16 shows a representation of the nutrient delivery system (i.e. the nutrient center), the system having a plurality of fluid tanks, the componentry for feeding and draining fluids to/from the tanks, and showing how the system is used so as to pump filtered nutrient rich solution to the growth chambers;

FIG. 17 shows a dosing system according to embodiments including, for example, storage containers and pumps for controlling pH and nutrient levels (up to four), and dispensing of a hydrogen peroxide mixture to the fluid tanks of the nutrient deliver system;

FIG. 18 shows a representation of the present air treatment system according to embodiments, the system including for example CO₂ enrichment, sanitizing, temperature and humidity control; and

FIG. 19 shows a representation of a growth chamber including for example air, light and nutrient solution control, and monitoring instrumentation.

### DETAILED DESCRIPTION

Although several embodiments, examples, and illustrations are disclosed below, it will be understood by those of ordinary skill in the art that the invention described herein extends beyond the specifically disclosed embodiments, examples, and illustrations and includes other uses of the invention and obvious modifications and equivalents thereof. Embodiments of the invention are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention. In addition, embodiments of the invention can comprise several novel features and no single feature is solely responsible for its desirable attributes or is essential to practising the inventions herein disclosed.

Embodiments herein relate to improved aeroponics systems and methods of use, and specifically to improved aeroponics systems and methods for the controlled cultivation of a plurality of plants, such as marijuana plants. It is known that aeroponics systems for growing plants must be closely monitored and tightly controlled to optimize growing conditions, particularly where the plants being cultivated are marijuana plants, or the like. The present system aims to provide an improved aeroponics system having maximized grow space for cultivating a large crop of plants within the system, while providing a closed-loop system to minimize exposure of the plants to contamination and human interaction.

By way of background information, U.S. Patent Application Pub. No. 2017/0223912 (the '912 Application) provides a detailed description of conventional aeroponics systems that are used for growing plants, such as marijuana plants. As follows, a general outline of known aeroponics apparatus and methodologies are is provided, the outline being reproduced generally from '912 Application to establish the basic principles of aeroponics systems, and then embodiments of the presently improved aeroponic apparatus and methods of use are introduced.

Aeroponics Plant Growing Systems Generally

As outlined in the '912 Application, methods, apparatus and systems for aeroponically growing plants, such as marijuana plants, involve various subsystems that interact in feedback loops to provide the tightly-monitored and controlled growing environment, whereby exposure of the plants to sources of contamination (e.g. pesticides, mold, mildew) in the air or water are minimized, and whereby plant yield is maximized. Control of such subsystems may be automated, with feedback signals from various sensors monitoring the environment. The systems are often configured to minimize human interaction with the growing environment. For example, problem detection may be mitigated by automatic adjustment of operational parameters and alerts provided to an operator permitting the operator to intervene manually where required.

Growth Chamber:

The environment required for aeroponic plant growth is known to be contained within a physical structure, referred to as a ‘growth chamber’, which is specifically designed for planting and irrigating the plants. The chamber itself comprises means for supporting the plants, such plant support means configured to permit exposure of the roots of the plant to air in the climate controlled “root zone” and permitting a nutrient-rich solution to be sprayed on the roots via an irrigation system. The walls of the growth chamber may be configured to envelope the structure containing the plants; provided that air flow into the chamber and past the plants is permitted. The walls may comprise any suitable material for maintaining an aeroponic environment, such as a non-porous light-reflective material. Generally, the growth chamber may further comprise one or more access panels for service and maintenance of the structures inside the chamber.

Lights:

Artificial lighting may be evenly dispersed about the chamber to illuminate the plants. Lighting systems used for the aeroponic growth of plants must be closely monitored and controlled. Known systems are increasingly using horticultural appropriate smart LED lighting systems (e.g., Raging Kush®, SCYNCELED, USA). Such systems, which may be specifically designed for large growing operations, can be suitable for controlling light intensity and scheduling (e.g., day/night cycles), for addressing high humidity, and for use in frequently cleaned environments. Ideally, such lighting systems may serve to maximize lighting within limited space. At least one sensor may be positioned within the growth chamber for monitoring lighting systems, such sensor being used alone or in conjunction with temperature (and other) sensors as described in more detail herein.

Temperature, Pressure, Humidity:

Temperature, pressure, and humidity within the growth chamber used for aeroponic plant growth must be closely monitored and controlled. Air temperature and humidity sensors may be used to monitor temperature and humidity levels and gradients within the growth chamber. In some embodiments, signals received from the sensors can be used to prompt a controller to operate air moving device(s) and HVAC in order to maintain the temperature and humidity levels and gradients within the chamber. In other embodiments, signals received from the sensors can be used trigger an alert to an operator, for example, where the conditions within the chamber cannot be adapted or the environmental controls cannot be maintained by the controller alone. As would be understood, temperature and humidity sensors may be independent sensors, may be integrated into one sensor, or may be a combination thereof

Barometric Pressure:

In addition to temperature and humidity, barometric pressure within the aeroponic growth chamber may be closely monitored and controlled. In some embodiments, barometric sensors may be provided, such sensors operative to measure the pressure in the air or other fluid at the sensor.

Air Flow:

Air flow within the growth chamber should be closely monitored and controlled. Known aeroponic systems advantageously allow for the customization of air flow within the chamber in order to cause plant swaying and motion, thereby reducing dead air pockets and stimulating the plants to produce more fibrous stalks. As a result, the plants become more durable to handle, they can support a heavy crop, and less prone to wilting if undesirable conditions accidentally arise.

Aeroponic growth chambers can comprise cooling and ventilation (HVAC) systems including, for example, one or more air moving devices (e.g., fans, blowers, etc.), air conduits (e.g., tubes, ducts, etc.), air conditioners, and air filters (e.g., carbon filters, HEPA filters, etc.). It is an advantage that the cooling and ventilation system may operate mainly on recirculated air for efficiency and to minimize the amount of air being filtered at the inlet and outlet to the environment where contamination could enter or leave the growth chamber. In some embodiments, one or more exhaust air sensors can be positioned proximate an exhaust outlet of the growth chamber to monitor concentrations of contaminants in air exhausting from the chamber, and to compare such contaminant concentrations with background levels outside the growth chamber (or predetermined and desired baseline levels within the chamber). If desired, the proportions of recirculated and new air may be adjusted automatically by variable speed air movers.

Feedback Control/System Automation:

Measurement of the above-referenced and various other parameters within aeroponic growth chambers facilitate feedback loops to a controller, thereby establishing automatic (or semi-automatic) control of the environment, and enabling optimization of the growing conditions for the plants and operational functions of the growth chamber. It is an advantage of aeroponic plant growing systems that measurements acquired by various sensors can be sent as signals to a controller, which then responds to the signals in a manner consistent with programming of the controller. For example, based upon signals received from the sensors, variables within the chamber can be modified including, without limitation, the “day/night” light cycle timing, temperature and humidity levels, air flow rates and oxygenation levels, timing and duration of nutrient delivery, concentration of nutrients and/or pH levels within the solution (i.e. tailoring the solution, via the dosing regimen to optimize development of the specific plants), sanitation cycles to clean and maintain the growth chamber, etc. Aeroponic growing systems operated in this manner are therefore not only able to accurately monitor the growth chamber environment based upon actual parameter values received from the sensors, but are also able to take any action as may be necessary to adjust the environment to optimal growing conditions. By way of example, when adjusting the pH, the nutrient-rich solution may be mixed and continuously sampled with a pH sensor to determine whether the action taken had the desired result. Or that varying the speed of a fan to change the airflow adjacent the plants, barometric pressure may be determined within the growth chamber in order to ensure that the intended air flow changes actually occur.

Nutrient Delivery or “Irrigation” System:

Aeroponic growing systems operate on the ability to provide a nutrient-rich water solution to the roots of the plants. As such, aeroponic systems require a nutrient delivery system, also referred to as an “irrigation” system. Specifically, growth chambers can be separated into a “root zone”, a “stalk zone” for supporting the stalk of the plants, and an upper “canopy” zone. Nutrient delivery systems can comprise one or more pumps fed from one or more nutrient tanks (e.g. a dosing system), with fluids first passing through at least one filters (e.g., particle filters). The one or more pumps often pump the nutrient-rich solution to at least one solution delivery header in or proximate to the growth chamber. A pressure monitoring sensor, located proximate to a furthest point in the delivery header, may provide feedback to the controller to control the one or more pumps to adjust the pressure to a desired level in order to compensate for solution losses in conduits and a variable number of growth chambers, which may be irrigated at any given time.

The delivery header may be in fluid communication with the growth chamber via one or more valves. Opening and closing of the one or more valves may follow timing patterns set by the controller and may vary depending upon the growth phase of the plants, or other such factors as would be known to a person skilled in the art. The one or more valves may feed distributors that are in fluid communication with a plurality of sprayers (e.g., nozzles) within the root zone. Nutrient-rich solution may be provided to the sprayers at a sufficient pressure to create a mist in the root zones, thereby saturating the roots of the plant. A skilled person would know and understand that variations of the chemical components of the solution, or of the cycle timing that the solution is administered, may be made in order to optimize plant growth (and to control the root length/mass).

The nutrient-rich solution that is not absorbed by the plants may flow down to the bottom of the plant support structure, before draining from the growth chamber through one or more drains and, depending on the system, may be recycled or discarded. Sensors may be provided to measure and monitor fluid runoff rate and collected volume within the chamber. In some embodiments, at least one level probe may be provided, giving a digital indication of whether or not liquid is present at a predetermined measuring point, which might indicate that collected liquids have reached high-level limit (and that the introduction of more nutrient-solution should be decreased), or that a fluid-flow blockage has occurred in any one individual plant support structure. Signals received from the at least one level probe can be used to prompt the controller when a problem is detected and, where desired, to immediately stop whatever action is causing a rise in the liquid level. Where required, an alert may be provided to an operator permitting the operator to intervene manually. Information collected from individual sensors, or from a combination of a plurality of sensors can provide useful information to the controller and/or operator for use in logical decision making in combination with other input variable.

Nutrient Solution Dosing System:

Aeroponic growing systems typically comprise a nutrient-rich solution dosing system to ensure that fluids sprayed onto the roots optimize plant health and growth. Dosing systems can comprise one or more tanks for mixing and storing the solution. It would be understood that the number of tanks may depend upon the number of different kinds of chemical components, the chemical components being stored individually in separate storage containers. Typically, the nutrient-rich solution may be a water-based solution comprising other chemical components including, for example (and without limitation), nutrients, acid, alkali, trace elements, flavor additives, hydrogen peroxide, enzymes that facilitate plant processes for plant growth, sugars (e.g., glucose, sucrose), marker dye (e.g., organic dye), and the like. Each separate storage container for chemical components may further comprise, for example, a sensor for measuring an amount of the chemical in the container, a metering pump for delivering a measured amount of the chemical component out of the container, and associated conduits (e.g. lines, tubing). In some embodiments the solution from the system may be recycled and then supplied back into the system. However, the system may also comprise a purge drain for circumstances where it may become necessary to empty the solution from the system.

At least one sensor for monitoring levels of chemical components and other parameters may be located at any suitable location in the system, for example, in or more tanks, in a conduit that eventually leads to the growth chamber from the tank, or in a conduit that eventually leads back from the growth chamber to the tank. Fluid flow through the system may be measured and monitored to ensure that nutrient-rich solution is flowing past the sensors representing the state of the solution correctly. pH may be measured to determine the acidity of the solution. Conductivity may be measured to derive Total Dissolved Solids (TDS) content of the solution. Dissolved oxygen may be measured to determine residual O₂ in the solution as an indirect measurement of peroxide level, reducing biological oxygen demand (BOD) with peroxide or just from aeration of the solution. As above, a temperature sensor may be used to ensure that the temperature of the solution is maintained within a suitable range, and also to provide a calibration temperature for other sensors which require calibration. A colorimeter with a light source may be used to check the solution for any discolouration from algae, turbidity, undissolved solids, etc., and also to measure residual levels of enzyme or peroxide based on the rate of breakdown of a marker dye.

As would be understood, during operation at different phases of the life cycle of a plant, such as a marijuana plant, preparation of the nutrient-rich solution may be done using target levels for certain parameters, such as total dissolved solids (TDS), pH, dissolved oxygen saturation, BOD, and enzyme concentration, etc. Target levels may be further broken down into desired compound proportions based on which chemical components contribute to the target. For instance, a dosing system having a feedback loop with the controller may be used to determine how much of which chemical component to add to compensate when the target levels are out of specification and then implement any required changes. It should be understood that target levels may change due to plant uptake, evaporation etc., but also from “day” to “night”, and such levels may vary in a non-uniform or non-linear fashion within a growing cycle phase. Dosing systems may be configured to constantly and automatically determine current target levels, and work to bring all measured parameters back into a desired range if deviation occurs. For example, if the pH is too low, alkali may need to be added, if pH is too high, acid may be added, if the total dissolve solids (TDS) is too low, nutrients and/or flavour additive may be added, the dissolve oxygen is too high, the solution may be drained and then deionized water added to the drained solution and a hold period implemented to stop recirculation of the solution for a period of time, if dissolved oxygen is too low, hydrogen peroxide and/or enzymes may be added, circulation rate increased and aeration implemented (if available), if enzyme level is too high, the solution may be drained and then deionized water added to the drained solution and, if enzyme level is too low, enzyme may be added.

Root management including the ability to control root ball (root mass) size is a particularly useful aspect of the nutrient-solution delivery system. It is desirable to effectively and efficiently to control the size of the plant's roots, including reducing chance of plugging the root zone, allowing easy removal of the plants from the plant support structure, reducing disposal cost of plant matter, using nutrients more efficiently to bias growth to marketable parts of the plant, accelerating growth of the plant by optimizing uptake abilities, and creating a more robust plant earlier in its life. The process may be used to quickly grow roots to a desired size and then slow further growth, dedicating plant energy to the above ground portions of the plant for more efficient and faster growth.

System Management Controllers

Management controllers associated with each growth chamber may be responsible for maintaining system parameters, so that failure of one growth chamber may not affect the others. The system management controllers may, via feedback loops, monitor and maintain specified conditions as outlined above, including, without limitation, lighting, air circulation, air pressure, air quality, temperature, humidity and the like. System management control may comprise a database for receiving all incoming sensor data, whereby the data may be recorded and saved. Rules or instructions for the logic of the control system and programs for growing cycles may be run. Pre-determined and adjustable set points may be provided to the management controllers, such that the system may be operated within that set of instructions until the set points are changed as the system changes to a different mode of operation, corrects for some ongoing changing condition, or in response to an operator manually making a change. System management controls may be accessed by interacting with a user interface, which may be remote with access provided through a network connection, for example through the Internet.

When signals from the sensors change, a rule engine may be processed to determine whether any modes of operation need to be changed, or if any conditions have crossed a threshold constituting an alert or an alarm. Alert or alarm may be driven by rules to determine, for example, whether such alerts are non-critical, need to be dealt with in a timely manner, or need to be escalated to alarm which demand more immediate attention. Alarms may be dispatched to an operator by any suitable method, for example via telephone, SMS messaging or the like according to operator preferences. System management controls may be semi-automated or entirely automated.

Despite all of the foregoing advancements in aeroponic plant growing systems, problems with known systems remain. For example, due to difficulties in regulating a micro-climate within the growth chamber, the systems described in the '912 Application are maintained under negative pressure. However, operating aeroponic systems under negative pressure results in at least two problems. A first problem is that the growth chamber (i.e. the micro-climate environment) is susceptible to air or water surrounding the system being drawn into the growth chamber (i.e., towards the lower air pressure) should a leak or a problem with the air flow within the chamber occur. Any mold, spores, or bacteria present in the air could be sucked into the chamber, damaging or killing the entire crop of plants. Any increased opportunity for un-treated air or water to enter the system significantly increases the risk of contamination and threatens the viability the entire system.

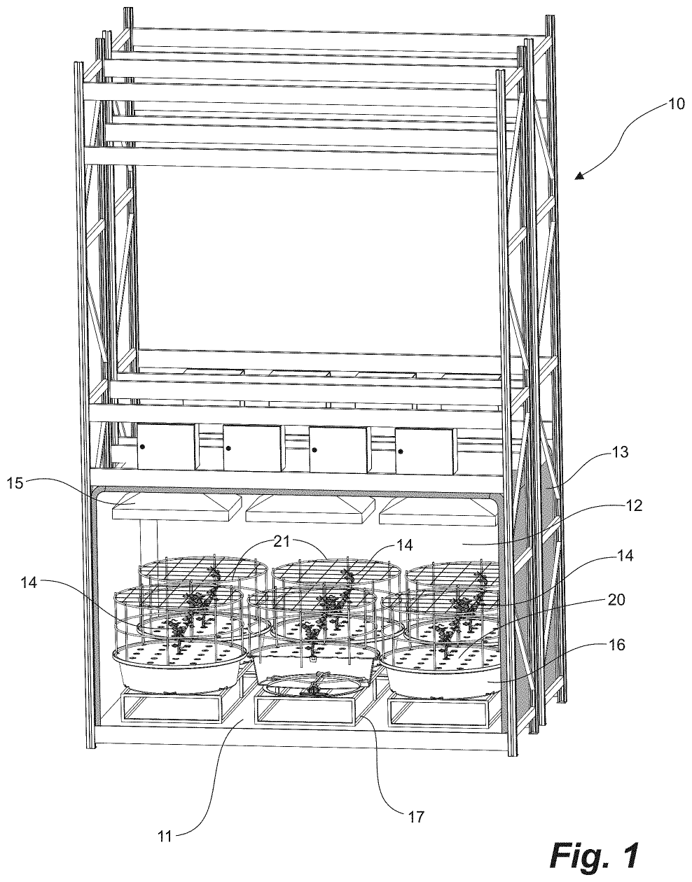

A second problem relates to difficulties in configuring a system that provides easy access to the plants. For example, the '912 Application describes a series of long rectangular “growing tubes” supporting the plants (#25, FIG. 1). In order to access individual plants within a tube for pruning or harvesting, the entire tube has to be slidably pulled out of the growth chamber like a drawer, disrupting all of the plants within that tube and potentially exposing the entire crop to contaminants outside of the chamber. The rectangular configuration of the growing tubes may also impede access to the centrally-planted plants, discouraging their care or, in some cases, causes damage to peripherally-planted plants when trying to “reach” past them to the of the tube. Also, due to the clearance required when sliding the growing tubes from the chamber (horizontally), a significantly larger footprint is required. That is—significant space in between each growth chamber must be present for the operator to walk in between the chambers to access each of the growing tubes and to withdraw them from the chamber.

Thus, by virtue of the system design and the required operation under negative pressure, the system described in the '912 Application renders the plants extremely susceptible to exposure from the surrounding uncontrolled environment. It would also be understood that the “drawer-like” design of the tubes limits or impairs access to piping, sensors, and air handling equipment in the system, increasing the risk of hosing becoming caught, tangled, or decoupled, and further increasing the overall footprint of the system and the cost of the space required to house the system which is often leased on the basis of the square-footage of the area. Similar drawbacks exist with other known aeroponics systems, resulting in a long-standing need for a more efficient and effective way of growing a large number of plants within a single, controlled growth chamber, while minimizing exposure of the individual plants within the chamber, and providing a compact, simple growing environment. More specifically, there remains a need in the aeroponics industry to provide plant growing systems that combine some of the features of the prior art, while overcoming their limitations and addressing their drawbacks.

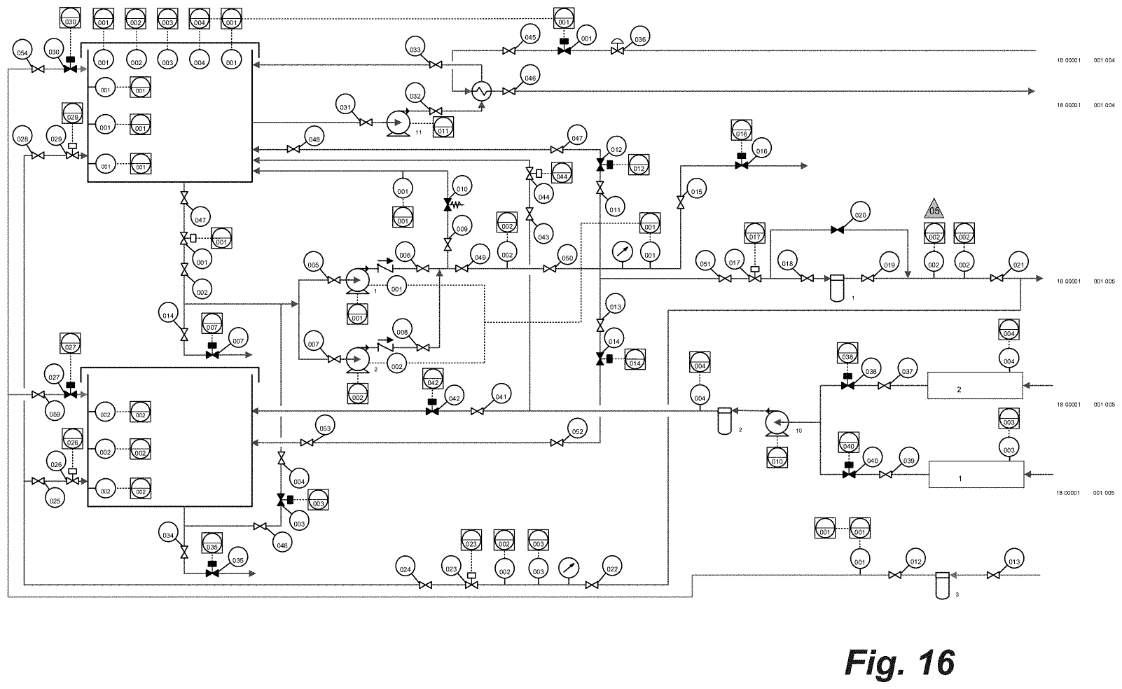

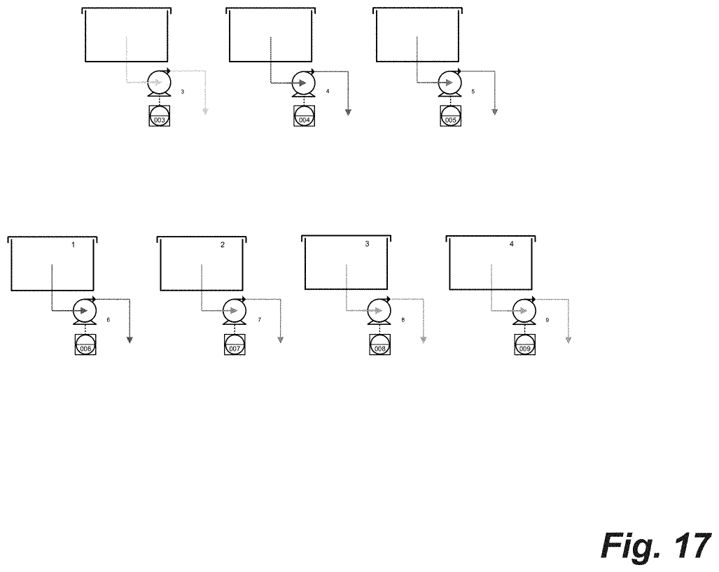

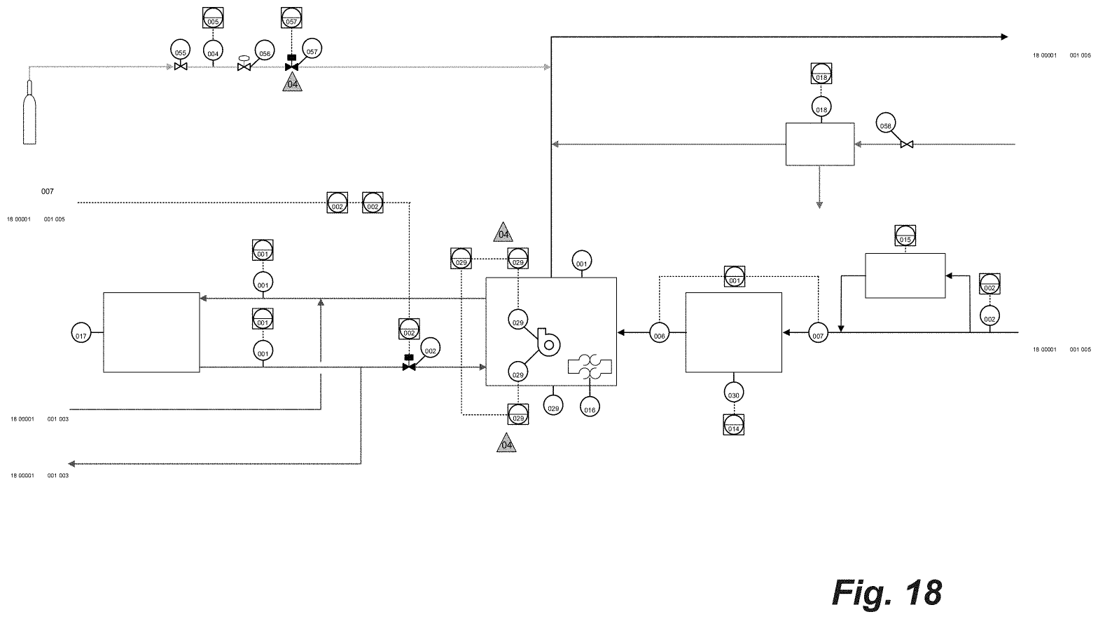

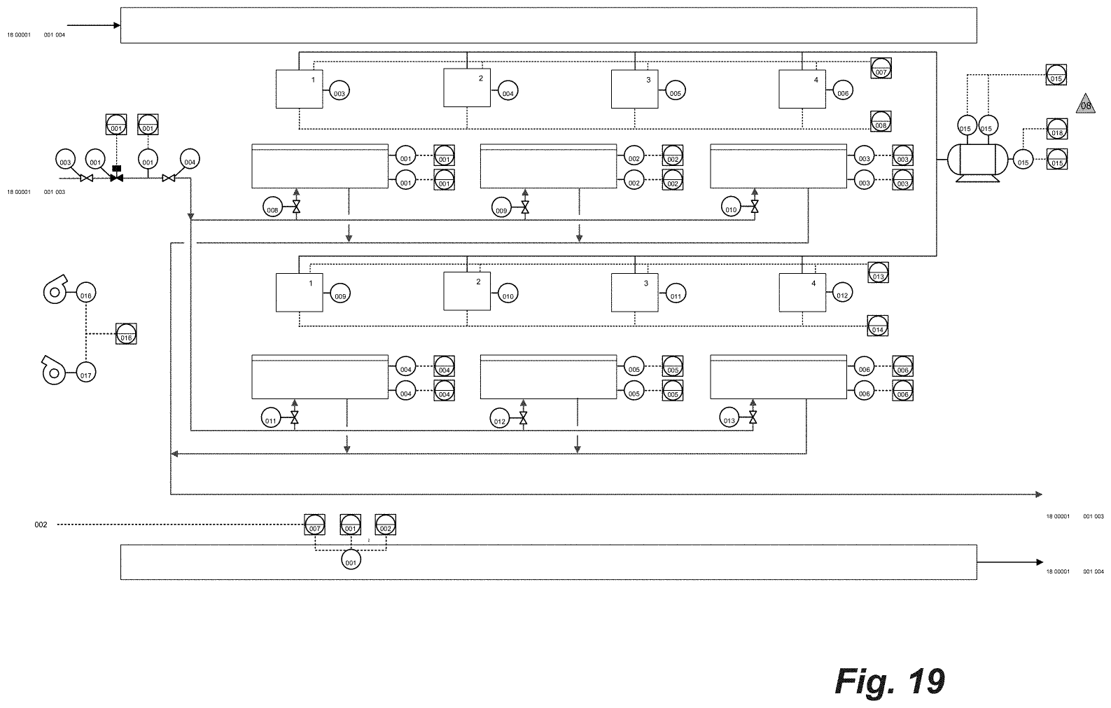

It is an object of the subject apparatus and methodologies to provide an improved aeroponics system having additional features for optimizing plant growth. Accordingly, an improved aeroponics plant growing apparatus and methodologies are provided, the apparatus and methodologies enabling large scale aeroponic plant growth within a closed-loop system, minimizing contamination of the crop by either the environment surrounding the system or by operator entrance to the system for pruning and maintenance. As will be described, it is an object of the subject apparatus and methodologies that the present improved aeroponics system be specifically configured to enable quick and easy disassembly of componentry for service, cleaning, and crop change over. The present apparatus and methodologies will now be described having regard to FIGS. 1-19.

FIG. 1 shows a perspective side view of the present improved aeroponics system 10 having a closed-loop, climate-controlled growth chamber 12 configured to receive and house a plurality of plants 14 grown without soil (only one plant per bin shown). In some embodiments, the present system may incorporate a plurality of growth chambers 12, each chamber 12 comprising a plurality of sensors for measuring and monitoring various environmental parameters within the chamber, and configured to facilitate control over the environment by a single controller, processor, or control system.

It is an advantage of the present system that measurements acquired by various sensors (e.g., temperature, humidity, air flow, barometric pressure, etc.) can be sent as signals to a single controller, the controller then responding to the signals in a manner consistent with programming of the controller. Preferably, a plurality of sensors may be positioned directly within each plant support structure 16, including levels for detecting fluid levels within the structures, temperature and humidity within the canopy and root zones, etc. For example, at least one temperature sensor may be used measure the air and fluid temperatures within each plant support structure 16 and/or within each growth chamber 12 (e.g., resistance temperature detectors (RTDs), gas chromatography sensors), for improved monitoring and control over the environment. At least one humidity sensor (e.g., capacitance sensors) may be used to determine the humidity and CO₂ levels within each plant support structure 16 and/or within each growth chamber 12, for improved monitoring and control over the environment. The at least one sensor for measuring humidity may be provided within proximity of the HVAC unit, ensuring control of the humidity before and after the air passes through the growth chamber 12. Moreover, the present system may comprise an air treatment system designed to detect and eliminate airborne contaminants and pathogens before they enter the growth chamber 12 (e.g., Air Sniper, USA).

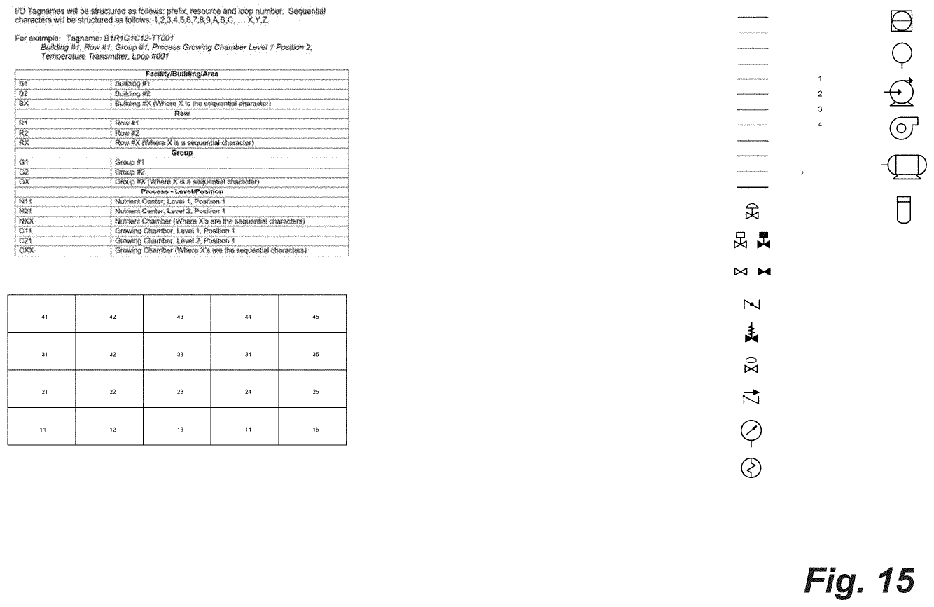

In some embodiments, where desired, the present system may be configured such that individual chambers 12 may be positioned so as to maximize the area of growing space, without increasing the overall footprint. For example, the present system may be configured such that individuals chamber may be positioned one atop the other in a ‘stacked’ arrangement in any number of levels (e.g., at least three levels high, FIG. 15), and aligned adjacent to one another (e.g., at least six chambers positioned together, FIG. 15), for a total of at least nineteen chambers 12 (where one chamber may comprise the nutrient delivery system). Advantageously, the ‘stackable’ nature of the present system allows for as many as three levels of growing space, providing a compact system having a reduced overall environment footprint without jeopardizing access to any of the plants 14 growing within the system. In some embodiments, chambers 12 may be sized according to user specifications, and for example may be approximately 8 ft (wide)×12 ft (long)×7 ft (high), or any other desired dimensions. It should be appreciated that, regardless of the configuration, it is an advantage that each of the chambers 12 of the present system may be individually monitored and controlled by one controller, computer, processor or the like, whereby parameters within each chamber 12 may be individually measured and controlled via separate feedback loop processing (see, for example, FIGS. 15-19).

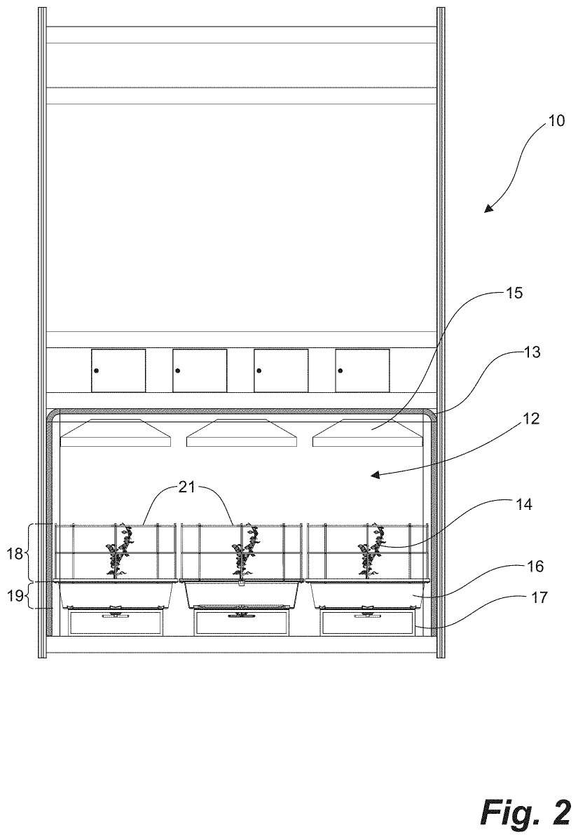

Having regard to FIGS. 1 and 2, each growth chamber 12 may be enclosed by a protective envelope or “wall” 13 (i.e., the wall including four sidewalls, a roof and a floor). Wall 13 may comprise any appropriate material for use in the aeroponic industry, including any non-porous or air-tight, light-reflective material suitable for the secure, sterile cultivation and management of plants. Wall 13 may comprise one or more ports enabling the control of the environment within the chamber 12, and where desired, providing access to the plants 14 being cultivated therein. In some embodiments, the wall 13 itself may be further enveloped, forming a vestibule-type space serving as an additional buffer zone between the environment and the growth chamber 12 (not shown).

According to embodiments, the present system 10 is configured to house a large crop of plants 14 within each climate-controlled growth chamber 12. For example, the system 10 may be configured to receive a plurality of plant support structures, referred to herein as “tubs” or “bins” 16. In some embodiments, each growth chamber 12 may be configured to receive at least six plant support bins 16. Bins 16 are configured to receive and support a plurality of individual plants 14 within close proximity. In some embodiments, each bin 16 is configured to provide an upper “canopy zone” 18 for supporting the plant canopy and exposing the plants 14 to the lights 15 thereabove, and a separate lower “root zone” 19 for supporting the plant roots or root ball and preventing exposure of the roots to the lights 15.

Bins 16 may be adapted to receive a plurality of plants 14, such as at least twenty-one plants 14, for upwards of one hundred twenty-six individual plants 14 being cultivated at one time within each chamber 12. Only one plant 14 per bin 16 is shown for illustrative purposes. It is contemplated that each bin 16 may be configured to support as many or as few plants 14 as may be desired by the user, and that proximity of the plants 14 to one another may depend upon the strain of plant being cultivated.

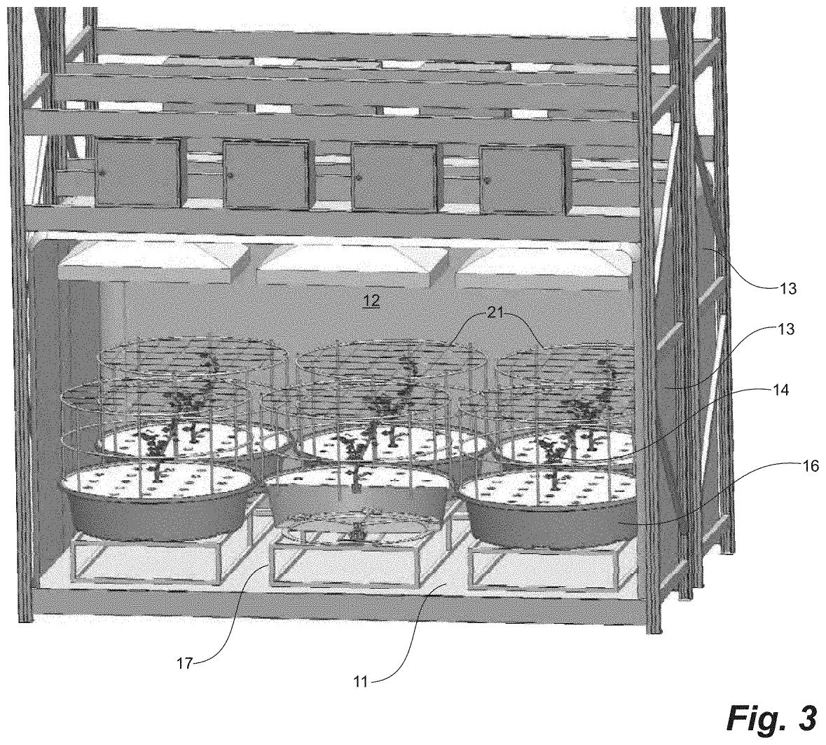

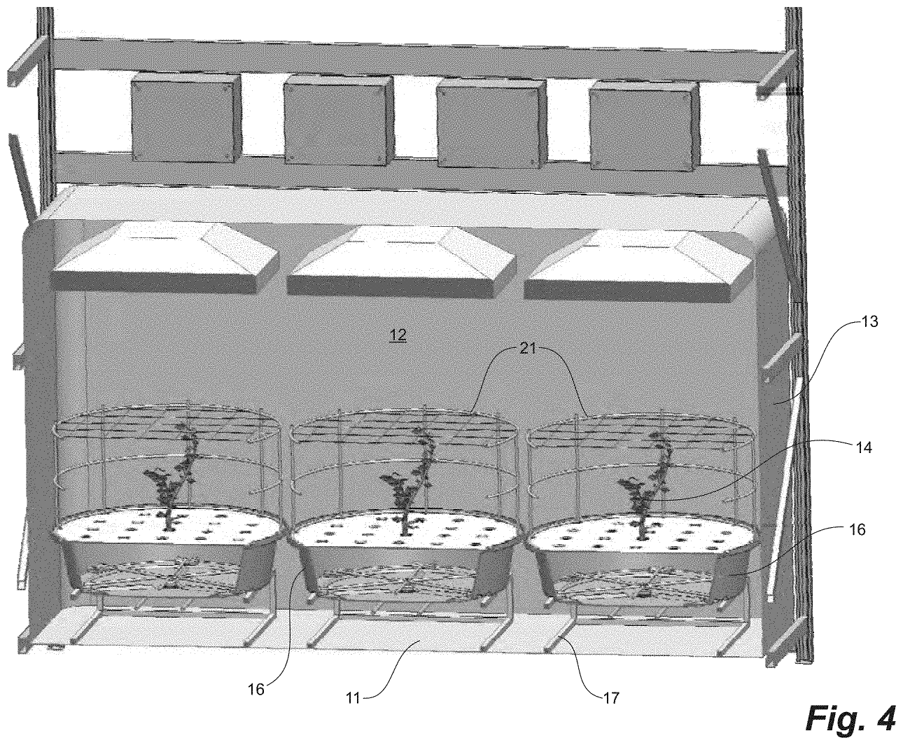

Having regard to FIGS. 3 and 4, plant bins 16 may be sized and shaped in order to maximize grow space and to minimize light or air flow dead-zones within the chamber 12. Moreover, bins 16 may be specifically sized and shaped in order to provide easy access to each individual plant 14, thereby reducing disruption to the crop during pruning and harvesting of individual plants 14. In some embodiments, bins 16 may be configured to be rotatable—that is, each bin 16 may be designed to be rotated about a central axis independently from one another (e.g. each bin 16 being rotatable about a central point such as a drain hole H, as will be described in more detail). It is contemplated that each bin 16 may be individually and freely rotated.

By way of background, attempts have been made in the aeroponic plant growing industry to provide rotatable systems, such systems, for example, being described in at least U.S. Patent Application Pub. No. 2012/0090236, U.S. Patent Application Pub. No. 2009/015144, and U.S. Patent Application Pub. No. 2019/0082619. Such systems, however, describe discrete individual plant growing structures that are only able to grow a small number or density of plants at one time. Such systems also require that the rotation of the plants be motorized and automated, and that the rotation is programmed to occur relative to, for example, light and air sources in order to provide consistent exposure to resources (e.g., for entirely robotic cultivation). Due to the individualized nature of each rotating plant “pod”, prior art growing systems necessitate individualized light and irrigation system for each pod, complicating the system componentry and increasing the footprint required for the overall system. There remains a need for a system that overcomes the deficiencies of known aeroponics systems, enabling the growth of large crops of plants at one time.

It is an object of the present system to provide for independent, manual rotation of each plant support structure 16 for the purposes of improving access to the plants 14 for pruning, inspection, and harvesting purposes. Where desired, operators may simply enter the chamber 12 and rotate only those bins 16 where plants 14 require attention, eliminating the need for the operator to reach across grow tubes, or to withdraw the plants from the chamber 12. Such enhanced accessibility to the plants 14 can reduce the time the plants are exposed air conditions outside of the growth chamber 12. Rotatable bins 16 also serve to prevent the clearance required around the bins 16 (i.e., with only space required around the outside of each grouping of bins 16), maximizing the total grow area compared to conventional fixed-tray systems (such as those described in the '912 Application above).

Although not required, it is contemplated that the bins 16 may further be rotated with respect to, for example, light and air sources within the chamber 12 (i.e., preventing dead zones). As may be appreciated, flexible maneuvering of plants 14 inside growth chamber 12 relative to, for example, light and air sources can allow even exposure to resources, improving the overall health and yield of plants 14.

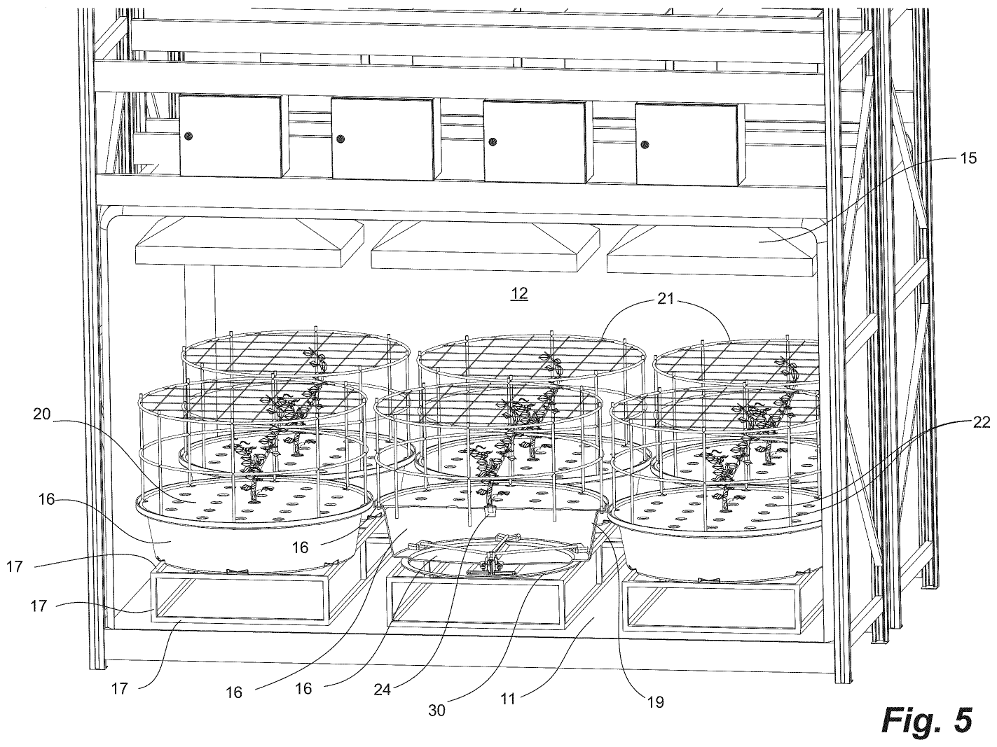

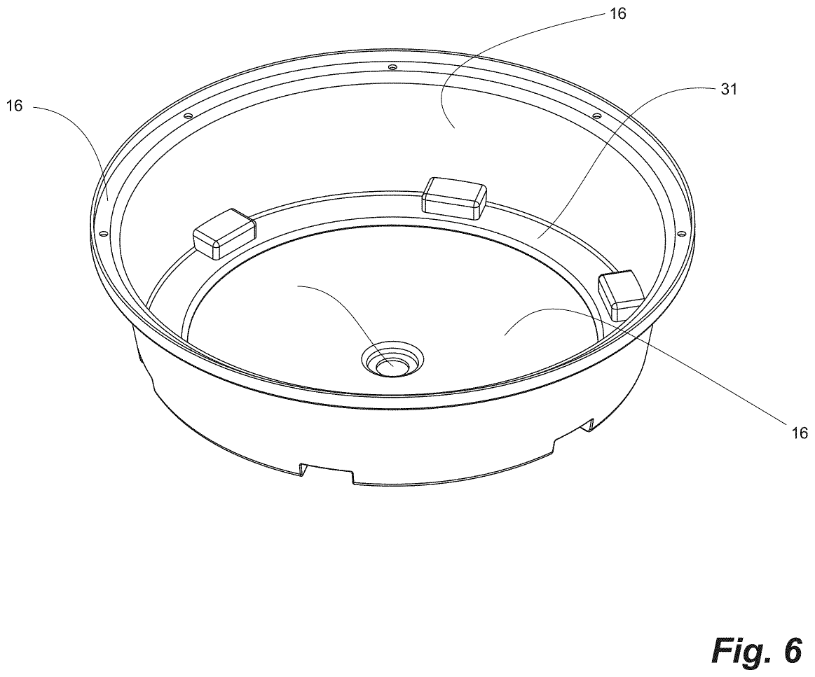

Having regard to FIGS. 5 and 6, in some embodiments, the present plant support structures or ‘bins’ 16 may be generally cylindrical in shape, having a circular cross section and having a bottom wall 16a and a sidewall 16b encircling its circumference. Bottom wall 16a may form drain hole H, and may be generally sloped downwardly encouraging fluid collecting on the bottom wall 16a to flow towards drain hole H.

Bins 16 may be rotatable about a turntable or track 30 (i.e., a lazy-susan style design), whereby bins 16 may be supported by the track 30 for rotation. Bins 16 may be configured to be removably mounted onto the track 30, and in some embodiments may form an annular groove 31 for corresponding with track 30. In operation, an operator may simply grasp a bin 16 about its sidewall 16b and manually rotate same until it reaches the desired position, without interruption to the irrigation system or disconnection from any componentry. Importantly, the bin 16 may be gently rotated about track 30, minimizing disruption to the plants 14 positioned within the bin 16. As will be described in more detail, bins 16 may also be configured for easy removal from the growth chamber 12 (i.e., via a quick-release pin mechanism) for cleaning and/or maintenance in between plant growth cycles.

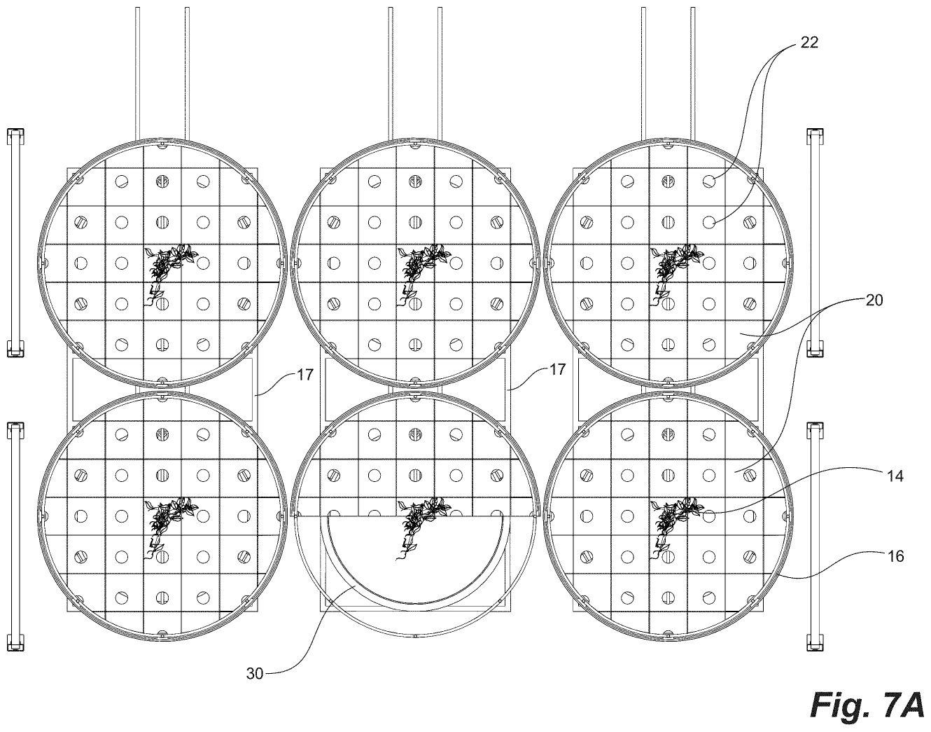

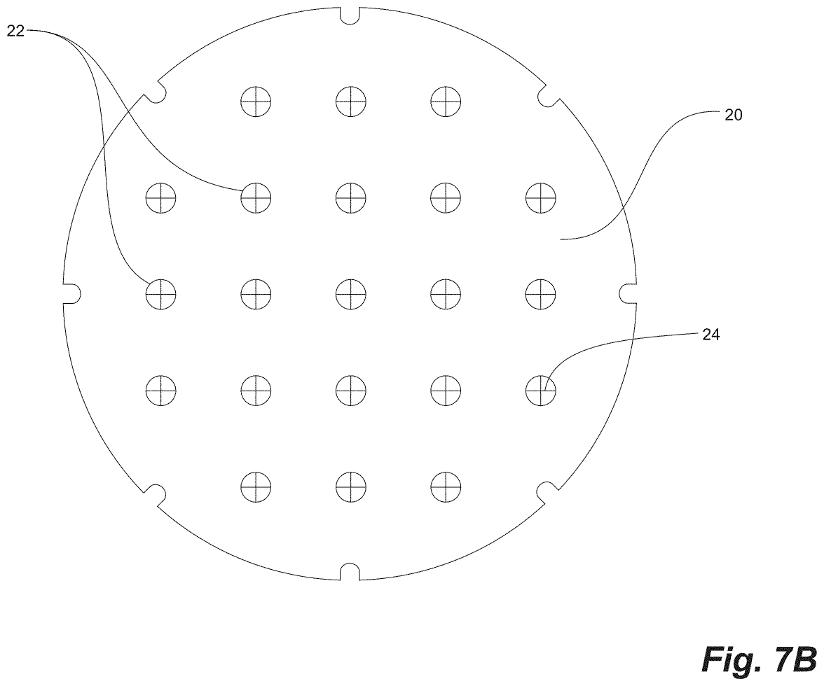

Having regard to FIGS. 7A and 7B, bins 16 may be adapted to receive and support at least one plant support divider 20, such divider 20 being rotatable with the bin 16. When dividers 20 are mounted within a bin 16, the dividers 20 create a plant-support tray or disc that extends around all or substantially all of the circumference of the bin 16 (i.e., divider 20 may be supported by and extend around the sidewall 16b of the bin 16). In some embodiments, bin sidewall 16b may comprise an annular flange or collar 16c for supporting divider 20, such that divider 20 can be easily removed from the bin for cleaning and maintenance, or where access to the irrigation system is required.

In some embodiments, the upper canopy zone 18 may be configured to provide at least one canopy support structure, such as a plant trellis 21, to provide easy access to the canopy of the plants 14 for pruning and harvesting, while minimizing disruption to the sensitive roots therebelow. Annular flange 16c may form at least one hole for slidably receiving and supporting trellis 21, although any other means for securely connecting a plant support structure to bins 16 are contemplated.

In some embodiments, dividers 20 may be configured to support a plurality of plants during their growth cycle. More specifically, dividers 20 may form one or more apertures 22 configured to receive at least one cup or basket 24 for supporting the stem and roots of the plants 14. For example, as would be known in the art, each aperture 22 may be configured to receive at least one root mesh cup 24 having a closed-cell foam disc (i.e., a root guard) for removably supporting the stalk of the plant 14, and mesh cup or basket suspended therebelow for enclosing the roots of the plant dangling inside. Dividers 20 may be manufactured from non-porous or semi-porous material, such that misting of the nutrient-rich solution is limited to the roots of the plants 14 growing below the dividers 20. Dividers 20 are also manufactured such that parameters within the “root zone” 19 may be independently monitored and controlled within each bin 16. FIG. 7A provides a top down view of the dividers 20 positioned within bins 16, one bin being shown in partial cross-section view (again only one plant 14 being shown in each bin 16 for illustrative purposes only).

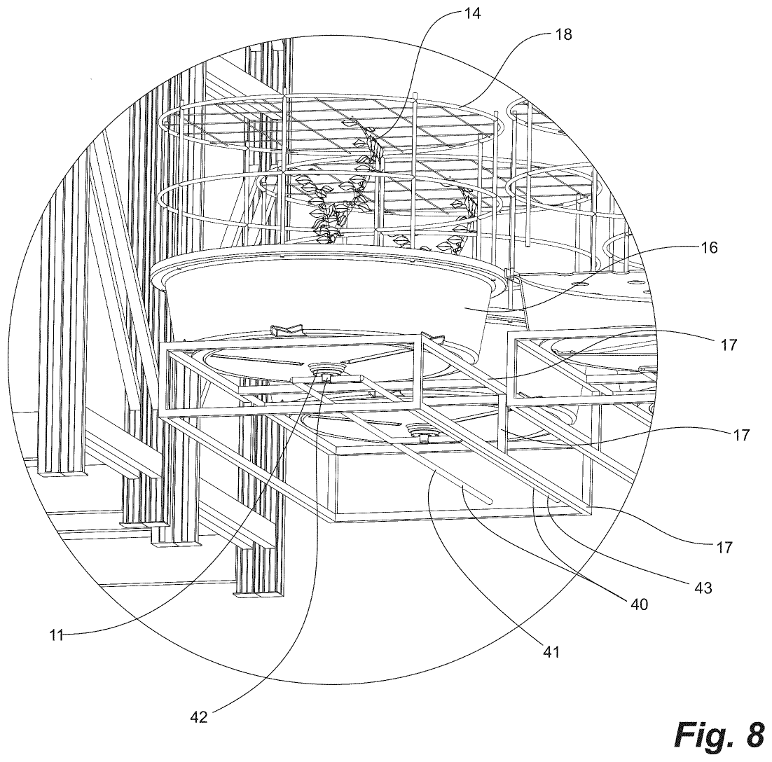

Having regard to FIG. 8, each plant support bin 16 (and corresponding track 30, as described above) may be supported by a base 17 for raising the bins 16 above the chamber floor 11. Bases 17 may be manufactured from any suitable material for supporting bins 16, and configured such that the height of the base 17 ensures that each bin 16 is within sufficient proximity to artificial lighting 15 thereabove.

Base 17 may be any size or shape suitable for supporting rotatable bins 16, with a rectangular base 17 being shown for illustrative purposes. In some embodiments, base 17 may comprise an upper portion 17a configured to receive bin 16, and a lower portion 17b configured to position the base 17 on the chamber floor 11. Upper and lower portions 17a,17b of the base 17 may comprise a plurality of support bars 17c therebetween, for reinforcing or strengthening the base 17.

Having further regard to FIG. 8, base 17 may also serve to support irrigation componentry 40 for the present system's nutrient delivery system 40, also referred to herein as the “irrigation system”. More specifically, upper portion 17a of each base 17 may be configured to support fluid communication lines 40 into 41 and out of 43 each bin 16. Fluid lines may establish communication with a delivery header 42, such headers 42 comprising one or more valve, such as a modified rotating coupler 50 (as described in more detail below). Fluid lines 41,43 may each have check valves positioned along the lines, such valves being associated with fluid flow sensors for monitoring and controlling fluid flow through the lines into and out of each bin 16. Each header 42 may be in fluid communication with at least one manifold 44, positioned within the root zone 19, for distributing the nutrient-rich solution to the plants 14. In that regard, the present system is configured to provide one irrigation system that branches to a plurality of chambers 12, and then further to a plurality of bins 16 within each chamber 12 (see FIGS. 15-19).

Advantageously, the system provides one closed-loop irrigation system operative to irrigate a large crop of plants on an individualized basis (i.e., to cycle fluids into and out of each plant support structure 16). It should be appreciated that such a configuration ensures that, where desired, irrigation to the plurality of plants 14 within one bin 16 may be modified or ceased, without impacting plants 14 in other bins 16. Moreover, where irrigation to one chamber 12 is modified (i.e., at the end of the growth cycle), irrigation to the remaining chambers 12 may continue uninterrupted. The present nutrient solution delivery system may also comprise one or more air and/or fluid chillers (e.g., coiled heat exchangers, or the like), to more accurately maintain the temperature of the nutrient-rich solution, which in turn serves to control the temperature in the root zone. As should be appreciated, the temperature within the root zone 19 is critical. It follows that stringent control of fluid temperature is also of critical importance (e.g., it is desirable to maintain the temperature of the oxygen-rich water solution within the root zone 19 at or near 18° C., or approximately 4° C. lower than the canopy zone 18). In preferred embodiments, the present system may comprise systems for injecting cool air into the root zone 19, such that temperatures within the root zone 19 are strictly controlled. Manifold 44 may support one or more nozzles (not shown) operative to deliver by “mist” or “spray” the nutrient-rich solution to the root zone 19 (e.g. under low and high pressure, or via ‘fogponics’). Nozzles may comprise any suitable spray or mist-type nozzle as desired, such nozzles being selected, for example, based upon coverage of the solution to the root zone 19, or based on droplet size delivered through the nozzles, etc.

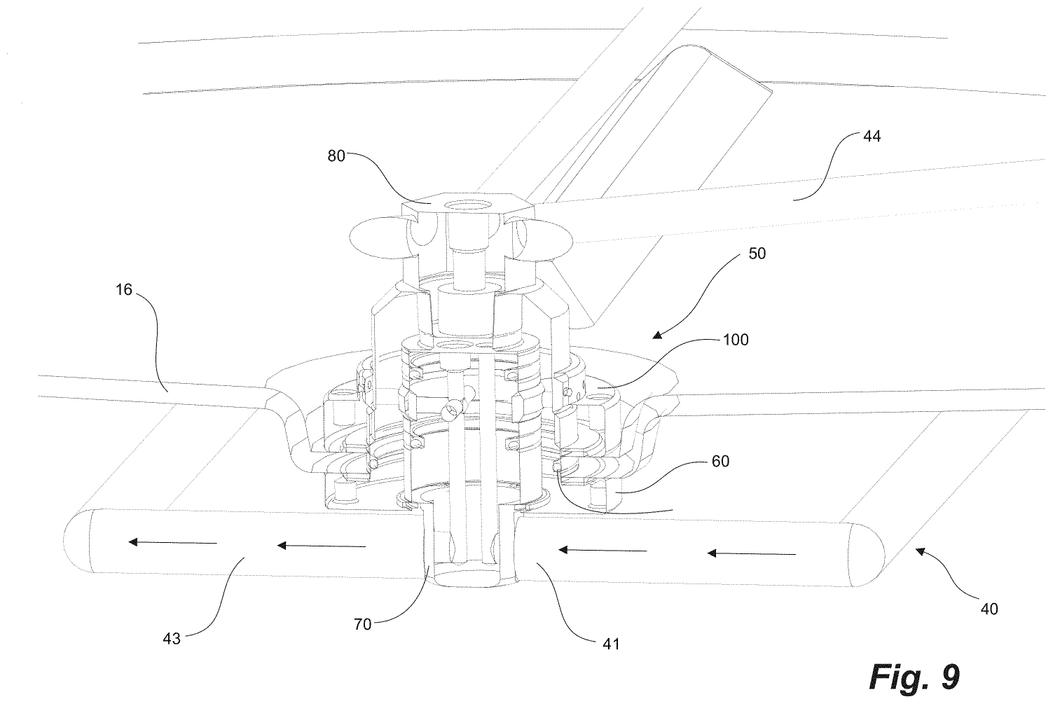

According to embodiments, the present system may be specifically configured to provide rotatable bins 16, whereby bins 16 can be manually rotated about a central axis without interruption to the irrigation system supplying nutrient-rich solution to each bin 16 (i.e., bins 16 may be rotated while the nutrient-rich solution is being delivered, and without disconnection from fluid communication lines into 41 and out of 43 each individual bin 16). According to embodiments, the present system 10 comprises at least one valve, such as modified rotating coupler 50, sealably positioned within the drain hole H of each bin 16, the coupler 50 serving as a rotatable bi-directional fluid passageway establishing communication between the irrigation system 40 and bins 16. More specifically coupler 50 operates to connect the fluid communication lines 40 of the irrigation system with the manifold 44 within the root zone of the bin 16. Coupler 50 may be further configured to enable quick and easy release of the manifold 44 from the bin 16, and/or of the bin 16 from the base 17, for easy cleaning and maintenance of the componentry. Coupler 50 will now be described in more detail having regard to FIGS. 9-14.

FIG. 9 shows a perspective partial cross-section side view of coupler 50 positioned within bin 16, and connected to irrigation system 40 and manifold 44. More specifically, coupler 50 may be sealably positioned within drain hole H, such that its lower end may be in fluid communication with the irrigation system 40 below the bin 16, and its upper end may be in fluid communication with the manifold 44. Fluid flow into and out of the bin 16 via coupler 50 thus provides a closed-loop system, whereby fluids can be recovered and recycled, or discarded (as desired). Coupler 50 may be specifically configured to be rotatably mounted within the bin 16, while providing a first fluid passageway for delivery of the nutrient-rich solution to the plants 14, and a second fluid passageway for removing excess solution draining from the plants 14. Advantageously, coupler 50 may be specifically configured for quick-release in at least two ways, the first where it is desirable to remove manifold 44 from a bin 16, and second where it is desirable to disconnect and remove a bin 16 from the irrigation system 40 therebelow.

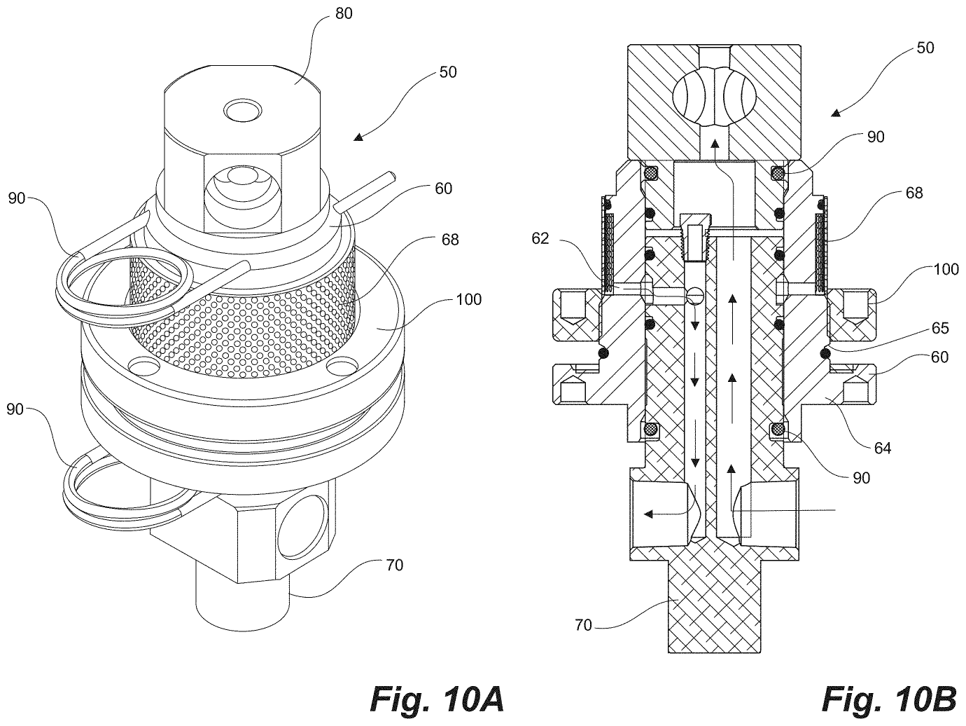

Having regard to FIGS. 10A and 10B, coupler 50 may comprise housing 60 for sealably connecting the coupler within the bin 16, and further for connecting a stationary coupler shaft 70, in fluid communication with the irrigation system, with a rotatable manifold (nozzle) mount 80, in fluid communication with manifold 44. Coupler 50 may be secured in positioned by any means known in the art, such as by lock nut 100 which may be threadably engaged with housing 60 from above bottom wall 16a. Advantageously, the present coupler 50 may be configured such that, when securely installed in the bin, housing 60, lock nut 100 and bin 16 may all rotate together (provided that lock-springs 90 are in place). As will be described, coupler 50 may be configured such that stationary shaft 70 may be releasably connected with housing 60, such as by a first quick-release connection. Coupler 50 may also be configured such that rotatable spray manifold mount 80 may be releasably connected with housing 60, such as by a second quick-release connection. More specifically, such quick-release connection may comprise a first quick release lock-pin between housing 60 and shaft 70, and a second quick release lock-pin between housing 60 and nozzle mount 80.

Housing 60 may be sized to be slidably received within hole H of the bin 16, and may form annular flange 64 for sealingly abutting bottom wall 16a of the bin 16. During assembly, flange 42 serves to prevent housing 60 from passing through hole H upwardly into bin 16 and, along with lock nut 100, may further provide means for securely clamping housing 60 to bin 16 (i.e., each of housing 60 and lock nut 100 provide holes for tightening the clamping connection during assembly, or loosening the connection during disassembly). In some embodiments, flange 64 and nut 100 may sealingly engage bottom wall 16a for preventing fluid flow through hole H. Flange 64 may form annular groove 65 for receiving an annular seal therein (e.g., O-ring and/or face seal (gasket)). It is understood that other means for sealingly engaging modified valve 50 within bin 16 are contemplated, as may be appropriate.

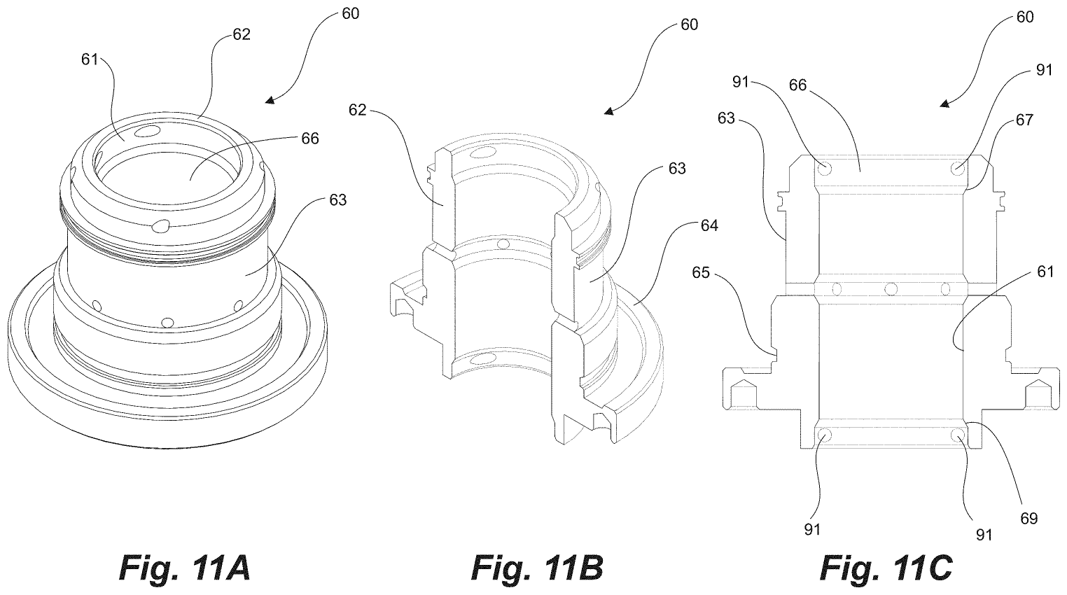

Having regard to FIGS. 11A, 11B, and 11C, housing 60 may form a substantially tubular body, the body having a cylindrical sidewall 62 with an internal surface 61 and an external surface 63, the sidewall 62 forming longitudinal bore 66 therethrough. As will be described, the internal diameter of bore 66 may be sized for slidably receiving and forming a sealed connection between coupler shaft 70 and nozzle mount 80. In some embodiments, the internal diameter of bore 66 may be consistent along its entire length. In other embodiments, the internal diameter of bore 66 may increase incrementally at each end of bore 66, such that internal surface 61 of sidewall 62 forms shoulders for abutting and preventing movement of coupler shaft 70 and spray manifold mount 80 within bore 66. For example, internal surface 61 may form upper annular shoulder 67 for abutting an restricting movement of nozzle mount 80, and may form lower annular shoulder 69 for abutting and restricting movement of coupler shaft 70. Moreover, as will be described, shoulders 67,69 align with annular grooves configured to receive a lock-spring 90. In that regard, about its upper and lower ends, sidewall 62 of housing 60 may form a plurality of pin holes 91 for receiving lock-spring 90 for quick-connection and release of housing from shaft 70 and of housing from mount 80.

External surface 63 may form at least one annular recess for removably receiving means for filtering fluids draining from bin 16. In some embodiments, means for filtering fluids may comprise an annular screen 68 (see FIG. 10A,10B). Screen 68 may be positioned at or near the bottom wall 16a, such that fluids flowing towards hole H pass through screen 68 before entering coupler 50. Screen 68 may be sealingly received within the recess on external surface 63. Moreover, sidewall 62 forms fluid port 62a therethrough for draining fluids passing through screen 68 into coupler 50 (see fluid flow arrows, FIG. 10B).

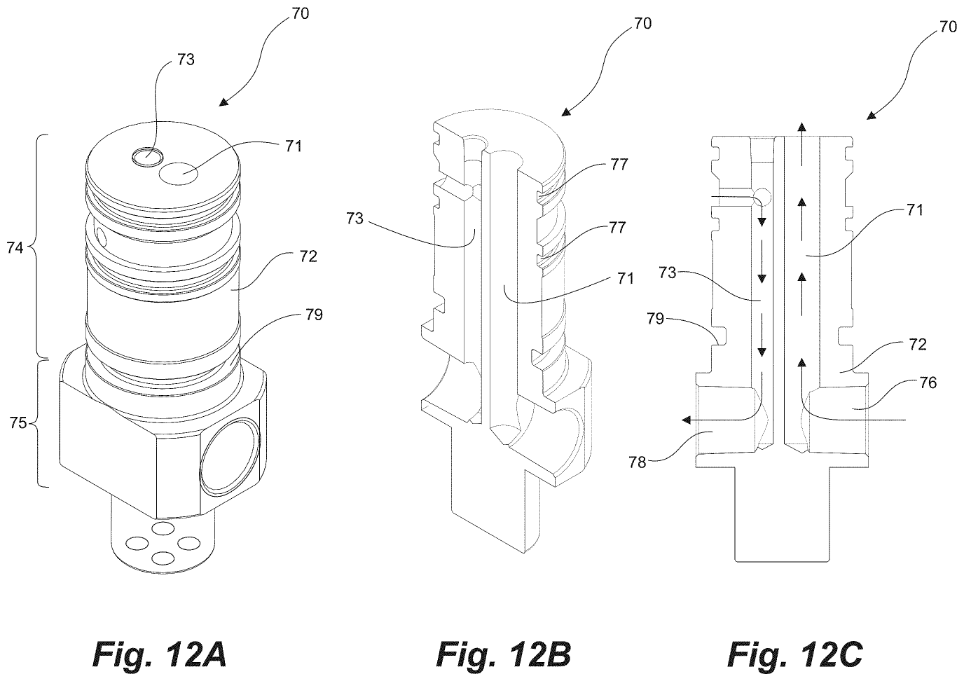

Having regard to FIGS. 12A, 12B, and 12C, coupling shaft 70 may form a substantially tubular body 72, the body 72 forming at least two distinct fluid passageways 71,73 therethrough. Passageways 71,73 may be L-shaped fluid passageways and may correspond, respectively, with the inlet and outlet fluids lines 41,43, of the irrigation system 40. In that regard, nutrient-rich solution delivered from the irrigation system 40 through line 41 enters coupler 50 and passes into bin 16 via L-shaped fluid passageway 41 via manifold 44 (and nozzles, not shown). Solution that is not absorbed by the plants 14 will drain back through coupler 50 through L-shaped fluid passageway 73 and out through return line 43 of the irrigation system (arrows, FIG. 10B). As should be appreciated, fluid draining from bin 16 into line 73 may first pass through filtering means (e.g. screen 68), or other filters as desired. It should be appreciated that upper end of L-shaped fluid passageway 73 is plugged or sealed, such that no fluid can enter into the passageway 73 but through screen 68.

Body 72 may comprise an upper portion 74 and a lower portion 75, the upper portion 74 being substantially cylindrical in shape and being sized so as to be slidingly received within bore 66 of housing 60. In that regard, the outer surface of upper portion 74 may form at least one annular groove 77a,b, . . . n for receiving an annular sealing member (e.g., O-rings), thereby preventing fluid flow through annulus of bore 66. The outer surface of upper portion 74 may, about its lower end, further form annular groove 79 for receiving lock-spring 90. Accordingly, it is desirable that annular grove 79 correspondingly align with shoulder 69 of housing for receiving lock-spring 90.

The lower portion 75 of body 72 may be being enlarged, relative to the upper portion 74, for accommodating the elbow portion of L-shaped fluid passageways 71,73. L-shaped fluid passageways 71,73 may, respectively, form an inlet 76 establishing connection between fluid delivery line 41 and fluid passageway 71 for transmitting nutrient-rich solution into bin 16, and an outlet 78 for establishing connection between fluid drain lines 73 and 43, for removing fluid from the bin 16 (see arrows depicting fluid flow, FIG. 12C). It would be understood that any connection means appropriate in the art, such as threaded connection means (not shown), may be used to establish fluid flow from the irrigation system 40 into and out of coupler 50.

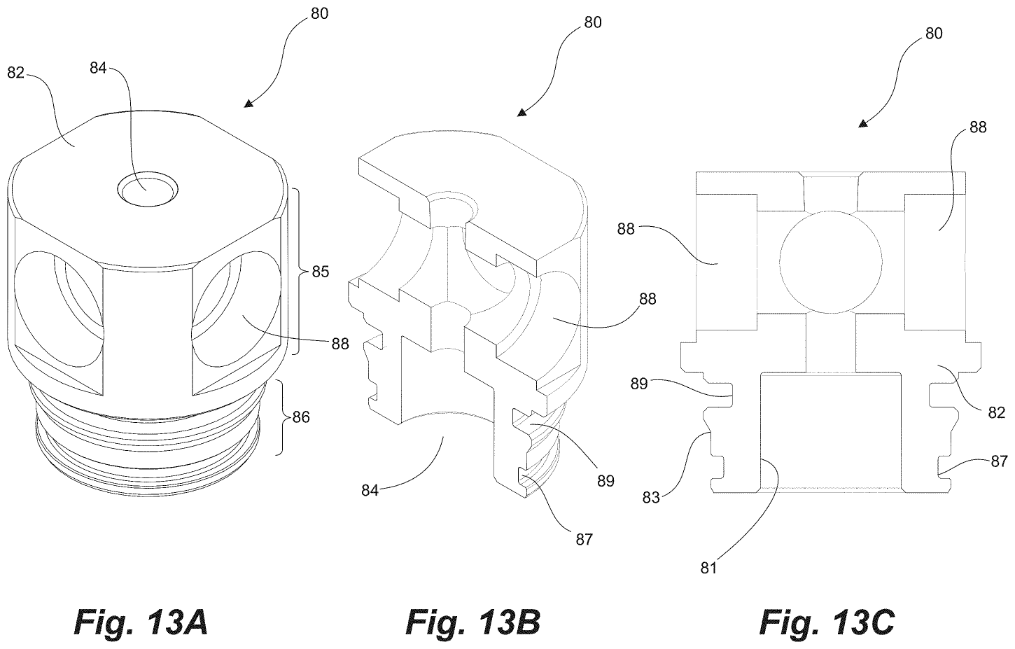

Having regard to FIGS. 13A, 13B, and 13C, spray manifold mount 80 may form a substantially tubular body 82, such body 82 having a sidewall with an internal surface 81 and an external surface 83, the internal surface 81 forming bore 84. Bore 84 may be configured to establish fluid communication between input fluid passageway 71 of coupler 50 and fluid control manifold 44 for distribution of fluids (i.e., via misting nozzles, or the like). In some embodiments, manifold mount 80 may be configured to receive fluids delivered from input fluid passageway 71 and to divert the fluid stream into one or more directions via a plurality of orifices 88.

More specifically, body 82 may comprise an upper portion 85, for mounting manifold 44 (i.e., such manifold 44 extends substantially horizontally therefrom), and a lower portion 86, for being slidably received within housing 60. Upper portion may form an annular shoulder for abutting upper end of housing 60, preventing movement of manifold mount 80 too far into bore 66 of housing 60. Upper portion 85 may form a plurality of orifices 88, such that nozzles can be mounted to spray fluids in any direction, as may be desired. It would be appreciated that orifices 88 may be sized and shaped in any manner so as to enable consistent fluid flow rates therethrough.

As above, lower portion 86 may be configured to be slidingly received within bore 66 and to form a sealed connection with housing 60. External surface 83 may form at least one annular groove 87 for receiving an annular sealing member (e.g., O-rings), thereby preventing fluid flow through annulus of bore 66. The external surface 83 may, about its upper end, further form annular groove 89 for receiving lock-pin 90. Accordingly, it is desirable that annular groove 79 correspondingly align with shoulder 67 of housing for receiving lock-spring 90.

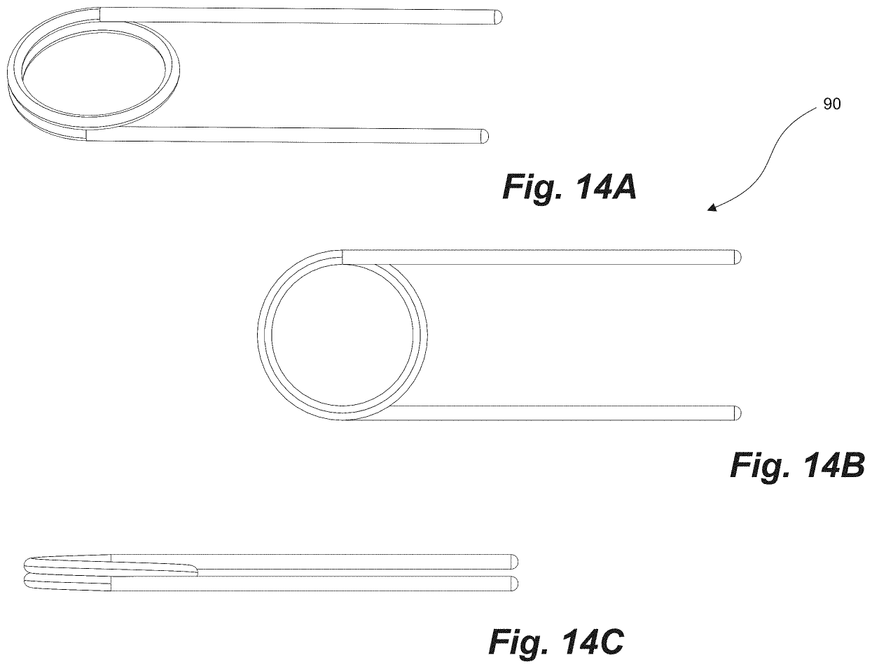

Having regard to FIG. 14, the present quick-release mechanism may comprise a lock-spring 90, or the like, configured to be slidingly received within pin holes 90. As such, an operator desiring to disengage manifold mount 80 from valve housing 60 may simply pull a first lock-spring 90 from pin holes between manifold mount 80 and housing 60. An operator desiring to disengage valve housing 60 from shaft 70 may simply pull a second lock-spring 90 from pin holes 91 between housing 60 and shaft 70 (first lock-spring may be in place, or may have already been disengaged). In some embodiments, lock-spring may be formed from a metal wire or other suitable material, the wire being bent into two coiled loops. In that regard, lock-spring 90 may be releasably inserted into pin holes 91 for securing the components of the coupler 50 together, or removed therefrom for quick-release disengagement of the coupler 50 components.

In operation, a method for growing plants aeroponically is provided, the method comprising providing a plurality of rotatable plant support structures 16 releasably positioned within at least one climate-controlled plant growth chamber 12, each plant support structure 16 being independently rotatable about a central axis, and having at least one valve or coupler 50 sealably positioned therein (e.g., in drain hole H). Each plant support structure 16 may contain a divider 20 for dividing the structure 16 into an upper zone 18 for supporting a canopy portion of the plants 14, and a lower zone 19 for supporting a root portion of the plants 14. The method may further comprise providing a nutrient-rich solution to the root portion of the plants 14 in the lower zone 19 and retrieving excess solution draining therefrom. The method may further comprise providing a plurality of sensors (not shown) for measuring the climate within each growth chamber 12 and generating signals indicative thereof, such signal being provided to a controller operative to receiving the signals from the sensors and, based on the signals, controlling the climate within each growth chamber 12.

It would be understood that the present methods comprise planting a plurality of plants 14 within each plant support structure 16 and supplying the root portion of the plants 14 with the nutrient-rich solution, and where desired, rotating one or more plant support structures to access the plurality of plants 14.

The present methods may further comprise providing at least one quick-release mechanism in each of the plant support structures 16 for removal of the plant support structures 16 from the growth chamber 12. The at least one quick-release mechanism may comprise a first lock-spring 90 for removing manifold 44 from the plant support structures 16, and a second lock-spring 90 for removing the plant support structure 16 from the growth chamber 12.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and the described portions thereof

We claim:

1. An aeroponic plant growing apparatus, the apparatus comprising:
at least one climate-controlled growth chamber containing:
a plurality of plant support structures for receiving and supporting a plurality of plants, each plant support structure independently rotatable about a central axis,
each plant support structure having a divider for dividing each plant support structure into an upper zone for supporting a canopy portion of the plant, and a lower zone for supporting a root portion of the plant, the lower zone of each plant support structure having at least one manifold for delivering the nutrient-rich solution to the root portion of the plants;
a nutrient delivery system in fluid communication with each plant support structure, the nutrient delivery system configured to deliver a nutrient-rich solution to the lower zone of each plant support structure, and to retrieve excess solution draining therefrom;
a plurality of sensors to measure the climate within each growth chamber, and to generate a signal indicative thereof; and
a single controller operative to receive the signals from the plurality of sensors, and programmed to individually control the climate within each of the plurality of growth chambers based on the signals;
wherein each plant support structure has at least one valve sealably positioned within the structure for establishing fluid communication between the nutrient delivery system and the at least one manifold for delivery of the nutrient-rich solution to the root portion of the plants.

2. The apparatus of claim 1, wherein the growth chamber is enveloped by a wall comprising a non-porous, light-reflective material.

3. The apparatus of claim 1, wherein the plurality of plant support structures are each rotatable while in fluid communication with the nutrient delivery system.

4. The apparatus of claim 1, wherein the plurality of plant support structures comprises at least six plant support structures.

5. The apparatus of claim 1, wherein the dividers may be removably mounted within the plant support structures.

6. The apparatus of claim 1, wherein the dividers form apertures for receiving and supporting the plurality of plants.

7. The apparatus of claim 1, wherein the at least one plant support structures are each mounted onto a base for supporting the nutrient-rich delivery system for cycling fluids to each at least one plant support structure.

8. The apparatus of claim 1, wherein some of the plurality of sensors are positioned within the lower zone to maintain the root portion of the plants at a temperature lower than the upper zone.

9. The apparatus of claim 1, wherein the valve comprising a rotating coupler having a housing for releasably connecting a stationary coupler shaft with a rotatable manifold nozzle mount.

10. The apparatus of claim 9, wherein the housing is releasably connected to the stationary coupler shaft, and releasably connected to the rotatable manifold nozzle mount.

11. The apparatus of claim 10, wherein the releasable connection between the housing and the stationary coupler shaft comprises a first quick-release lock-spring.

12. The apparatus of claim 10, wherein the releasable connection between the housing and the manifold nozzle mount comprises a second quick-release lock-spring.

13. The apparatus of claim 1, wherein the at least one growth chamber comprises a plurality of growth chambers configured in a stacked arrangement.

14. A method for growing plants aeroponically, the method comprising:
providing a plurality of rotatable plant support structures releasably positioned within at least one climate-controlled plant growth chamber,
each plant support structure being independently rotatable about a central axis, and having at least one valve sealably positioned therein,
each plant support structure having a divider for dividing the structure into an upper zone for supporting a canopy portion of the plants, and a lower zone for supporting a root portion of the plants;
providing a nutrient-rich solution to the root portion of the plants in the lower zone and retrieving, via a closed-loop system, excess solution draining therefrom;
providing a plurality of sensors for measuring the climate within each growth chamber and generating signals indicative thereof;
providing a controller operative to receiving the signals from the sensors and, based on the signals, controlling the climate within each growth chamber;
planting a plurality of plants within each plant support structure and supplying the root portion of the plants with the nutrient-rich solution; and
where desired, rotating one or more plant support structures to access the plurality of plants.

15. The method of claim 14, the method further comprising providing at least one quick-release mechanism in each of the plant support structures for removal of the plant support structures from the growth chamber.

16. The method of claim 15, wherein the at least one quick-release mechanism may comprise a first lock-spring for removing a manifold nozzle mount from the plant support structures.

17. The method of claim 15, wherein the at least one quick-release mechanism may comprise a second lock-spring for removing the plant support structures from the growth chamber.

18. The method of claim 14, wherein the method further comprises maintaining the lower zone of the plant support structure at a lower temperature than the upper zone.

19. The method of claim 18, wherein the temperature within the lower zone is approximately 18° C.

20. The method of claim 14, wherein the controller comprises a single controller, processor, or control system for controlling the plurality of plant growth chambers.
